(19) United States
(12) Patent Application Publication
(10) Pub. No.: US 2014/0217857 A1
(43) Pub. Date: Aug. 7, 2014

(54) ALTERNATOR FOR A MOTOR VEHICLE

(71) Applicant: Steven Evans, Viernheim (DE)

(72) Inventor: Steven Evans, Viernheim (DE)

(21) Appl. No.: 14/343,106

(22) PCT Filed: Aug. 20, 2012
(86) PCT No.: PCT/EP2012/066180

§ 371 Date: Mar. 6, 2014

(30) Foreign Application Priority Data
Sep. 9, 2011 (DE) 102011082442.1

(51) Int. Cl. H02K 7/18

(52) U.S. Cl. CPC H02K 7/1807
USPC 310/67 R

(57) ABSTRACT

An alternator for a motor vehicle includes a radial fan unit having a fan wheel with a plurality of radial fan blades. A magnetic field generator is arranged in the end region of at least two opposite fan blades. A magnetic coil arrangement is arranged around an outer circumference of the radial fan unit. When the fan wheel rotates the magnetic field generators induce an alternating current in the magnetic coil arrangement.

### FIELD

The invention relates to an alternator for a motor vehicle.

### BACKGROUND

Such alternators are usually used as generators for the operation of electrical accessories in motor vehicles. For this, the generators are driven via a V-belt and the pertinent pulleys by an internal combustion engine that is in the vehicle. Because of the increasing demand for electrical energy in modern motor vehicles as well as the limited available installation space, the desire exists for space-saving solutions for alternating current generation.

### SUMMARY

According to an aspect of the present disclosure, an alternator for a motor vehicle comprises a radial fan unit having a fan wheel, which has a plurality of radial fan blades, where at least one magnetic field generator is arranged in each of the end regions of at least two opposing fan blades so that when the fan wheel rotates, an alternating current is induced in a magnetic coil arrangement arranged along an outer circumference of the radial fan unit.

The invention makes use of the circumstance that most motor vehicles have an air-cooled cooling system for engine cooling, where a radial fan unit serves to supply the cooling system with cooling air from the outside environment. The alternator can therefore be implemented in most motor vehicles without an additional space requirement. In particular, the alternator may be used as an unregulated supplemental generator in addition to a conventional generator.

More precisely, the fan wheel has an even number of fan blades, and each of the fan blades has its own magnetic field generator. The magnetic polarity of adjacent magnetic field generators is chosen so that when the fan wheel rotates, a magnetic alternating current field is generated in the region of the magnetic coil arrangement.

Typically, the fan wheel has between 6 and 12 fan blades. The exact number of fan blades is governed firstly by the desired air flow rate and thus the cooling power of the radial fan unit.

Because of the relatively large diameter of the fan wheel and the outward mounting of the magnetic field generators in the end region of the fan blades, high magnetic flux densities can accordingly be generated in the region of the magnetic coil arrangement. Thus, for a fan wheel diameter of 550 mm that is common in agricultural tractors and a rotary speed range of 1200 to 2800 rpm, a circumferential velocity in the range of 4.5 to 10.5 m/sec is obtained.

To have alternator that is as compact as possible, the magnetic coil arrangement can be structurally integrated into a fan housing of the radial fan unit. The fan housing consists of, for example, fiber-reinforced polyamide or a similar plastic and is made in one piece in an injection molding process. The magnetic coil arrangement can be embedded in the plastic mass of the fan housing so as to be protected from external influences.

Moreover, there is the possibility that the magnetic coil arrangement comprises a soft iron ring with a plurality of radial slots or passageways, where the slots or passageways are designed to accommodate the coil windings of overlapping magnetic coils. The soft iron ring consists of a vacuum pressure impregnated stack of individual soft iron plates or transformer steel.

The magnetic coils can be arranged so that a three-phase alternating current is generated. In this case, the coil windings of a given magnetic coil are spaced three slots or passageways apart around the soft iron ring that is formed as the coil body. The magnetic coils, which are wound from enameled copper wire, are connected at one end to a common neutral point and at the other end to the corresponding terminals for supplying the three-phase current. The terminals can be made in the form of blade terminals or screw terminals on the outside of the fan housing.

In order to keep the air gap between the magnetic field generator and magnetic coil arrangement as small as possible, the magnetic field generator can run along a recess made in the soft iron ring. The recess preferably has a shape that corresponds with the outer contour of the magnetic field generator.

Moreover, the magnetic field generator can be structurally integrated into the fan blades. The fan blades are made of, for example, fiber-reinforced polyamide or a similar plastic in one piece in an injection molding process. The magnetic field generator can in this case be accommodated in a housing formed in the end region of the fan blade. The housing is formed either directly on the relevant fan blade or on a stabilizer ring running between the fan blades.

Preferably, the magnetic field generator is made as a permanent magnet. In order to achieve a magnetic flux density that is as high as possible, the magnetic field generator can consist of a neodymium-iron-boron compound.

### BRIEF DESCRIPTION OF THE DRAWINGS

FIG. 1 is a front view of an embodiment of an alternator in accordance with the invention;

FIG. 2 is a side view of the alternator along line A-A of FIG. 1; and

FIG. 3 is a sectional view along line B-B of FIG. 2.

### DETAILED DESCRIPTION OF THE DRAWINGS

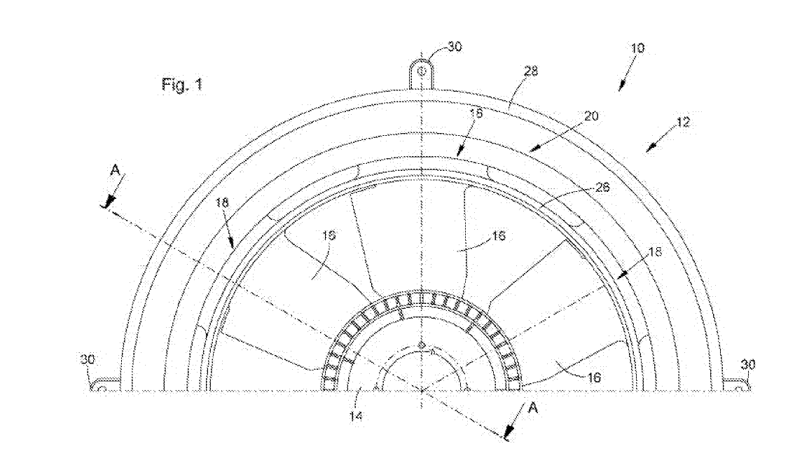

Components that are corresponding or comparable with regard to their function are indicated by the same reference numbers. FIG. 1 shows an alternator 10 for a motor vehicle (not shown). For clarity only half of the alternator 10 is shown.

Referring to FIGS. 1, 2 and 3, the alternator 10 includes a radial fan unit 12 with a fan wheel 14, which has a plurality of radial fan blades 16. A magnetic field generator 18 is arranged in each of the end regions of opposing fan blades 16. When the fan wheel 14 rotates, the magnetic field generator induces an alternating current in a magnetic coil arrangement 20 that is arranged along an outer circumference of the radial fan unit 12. The alternator 10 is driven by a V belt (not shown) and pulleys (not shown) by an internal combustion engine (not shown) of a motor vehicle (not shown).

As an example, the fan wheel 14 has six evenly spaced fan blades 16, and each of the fan blades 16 carries its own magnetic field generator 18. The magnetic polarity of adjacent magnetic field generators 18 is chosen so that a magnetic alternating field is generated in the region of the magnetic coil arrangement 20 when the fan wheel 14 rotates.

The magnetic field generators 18 are preferably permanent magnets 22, and north poles alternate with south poles in the direction of rotation of the fan wheel 14. The permanent magnets 22 preferably consist of a neodymium-iron-boron compound in order to generate a magnetic flux density that is as high as possible.

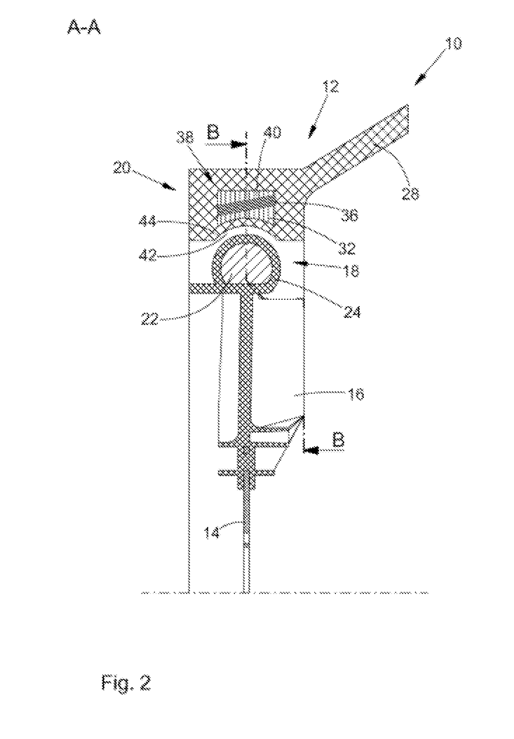

As best seen in FIG. 2, the magnetic field generators 18 are structurally integrated into the fan blades 16. Each magnetic field generator 18 is accommodated in a housing 24 that is formed in the end region of the fan blade 16. The housing 24 is formed either directly on the relevant fan blade 16 or, preferably on a stabilizer ring 26 that runs between the fan blades 16. Alternatively, the magnetic field generators 18 can also be arranged along the stabilizer ring 26 with an angular offset from the fan blades 16.

Moreover, the magnetic coil arrangement 20 can be structurally integrated into a fan housing 28 of the radial fan unit 12. The fan housing 28, like the fan blades 16, is preferably made of fiber-reinforced polyamide or a similar plastic and is preferably made in one piece by an injection molding process. The magnetic coil arrangement 20 is embedded in the plastic mass of the fan housing 28 and is thus protected against external influences. Several mounting tabs 30 formed on the circumference of the fan housing 28 serve to mount the alternator 10 in the motor vehicle (not shown).

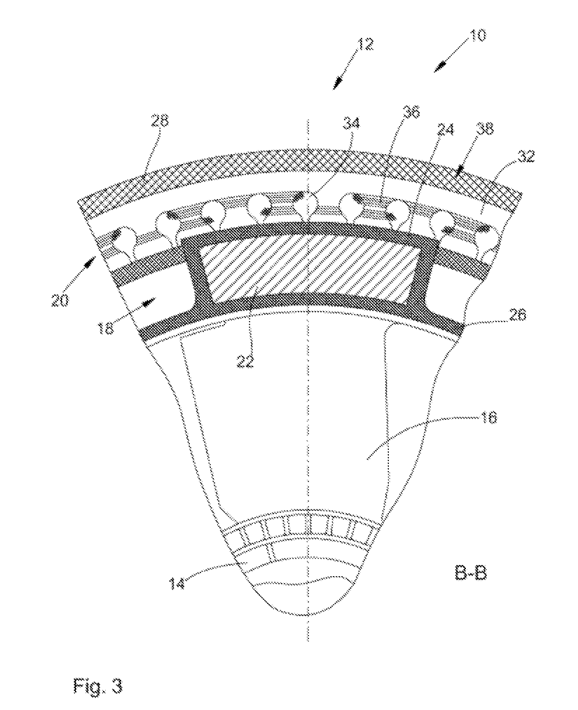

Referring now to FIG. 3, the magnetic coil arrangement 20 comprises a soft iron ring 32 with a plurality of radial slots or passageways 34, where the slots or passageways 34 accommodate coil windings 36 of magnetic coils 38 that are arranged in overlapping fashion.

The magnetic coils 38 are arranged so that a three-phase alternating current is generated when the fan wheel 14 rotates. The coil windings 36 of each magnetic coil 38 are spaced three slots or passageways 34 apart around the soft iron ring 32, which is made as the coil body. The magnetic coils 38, which are wound of enameled copper wire, are connected at one end to a common neutral point, and at the other end are connected to the corresponding terminals (not shown) for supplying the three-phase current. The terminals can be arranged on the outside of the fan housing 28 in the form of blade terminals or screw terminals.

As best seen in FIG. 2, the soft iron ring 32 consists of a stack of vacuum pressure impregnated individual soft iron plates or transformer steel 40. To keep the air gap 42 between the magnetic field generator 18 and magnetic coil arrangement as small as possible, the magnetic field generator 18 runs along a recess 44 made in the soft iron ring 32. The recess 44 has a shape that corresponds with the outer contour of the magnetic field generator 18. Alternatively, the recess 44 can also be formed so that it forms a pocket, within which the magnetic field generators 18 run.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1-8. (canceled)

9. An alternator for a motor vehicle, comprising:
a radial fan unit having a fan wheel and a plurality of radial fan blades;
a magnetic coil arrangement arranged around an outer circumference of the radial fan unit; and
a magnetic field generator is arranged in an end region of at least two of the fan blades, so that rotation of the fan wheel induces an alternating current in the magnetic coil arrangement.

10. The alternator of claim 9, wherein:
the magnetic coil arrangement is structurally integrated into a fan housing of the radial fan unit.

11. The alternator of claim 1, wherein:
the magnetic coil arrangement comprises a soft iron ring with a plurality of radial slots, the slots receive coil windings of magnetic coils that are arranged in overlapping fashion.

12. The alternator of claim 11, wherein:
the magnetic coils are arranged so that a three-phase alternating current is generated.

13. The alternator of claim 11, wherein:
the magnetic field generator runs along a recess formed in the soft iron ring.

14. The alternator of claim 1, wherein:
the magnetic field generator is structurally integrated into the fan blade.

15. The alternator of claim 1, wherein:
the magnetic field generator is a permanent magnet.
